(19) United States
(12) Patent Application Publication
(10) Pub. No.: US 2005/0225806 A1
(43) Pub. Date: Oct. 13, 2005

(54) Error diffusion using sub-pixel modulation

(76) Inventor: Niranjan Damera-Venkata, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/802,570

(22) Filed: Mar. 17, 2004

(51) Int. Cl. H04N 1/405

(52) U.S. Cl. 358/3.03; 358/3.23; 358/3.06

(57) ABSTRACT

A method of using error diffusion to generate a halftone image for an output device having capabilities to attenuate or modulate tone at a sub-pixel level. A lookup table is created, indexed based on possible exposure characteristics of pixels neighboring the pixel currently being processed. The lookup table, so indexed, outputs allowable exposure configurations for the pixel currently being processed, which allowable configurations are consequent to sub-pixel modulation capabilities of the output device. An exposure configuration is selected from the allowable configurations by comparison of a modified input value for the current pixel to the allowable configurations. The selected exposure configuration is then applied, and the modified input value and exposure value are differenced to generate a new error value to propagate forward in the error diffusion process. The process is repeated sequentially for each pixel according to the error diffusion technique employed.

### BACKGROUND OF THE INVENTION

1. Field of the Invention

This invention relates generally to halftone images, and more particularly to methods of implementing error diffusion in generating halftone images for use with output devices capable of modulating tone on a sub-pixel level. The techniques may be implemented in an apparatus, as methods, or as programs of instructions for directing an apparatus or machine to carry out the processing steps of these techniques.

2. Background

Many image rendering technologies, referred to generally herein as output devices, have only binary outputs with respect to any one particular element or pixel, whereby each pixel of the image either has a dot printed or not printed. Input or source images, however, may have a gray scale of much greater depth, most typically 256 different tones (0 through 255) defined by 8 bits associated with each pixel. Thus, for an output device to render a gray scale image, it is necessary therefore to convert source images comprised of higher order gray levels into halftone images.

(A pixel is just one location on the addressable grid; whereas a dot generally refers to a physical positive rendering or inking which can be composed of any number of contiguous pixels; meaning one, two or more contiguous (or closely proximate) pixels form a single dot. In order to avoid confusion and assist the reader in more fully appreciating the present invention, in the present description “pixel” or “sub-pixel” and similar terms such as “grid” will be used to refer to the addressable locations; whereas “pixel-dot” will refer to a single printed or turned on pixel and “dot” will be used in referring to printed clusters of more than one pixel. Additionally, though purely a matter of convention, for the purposes of this description, a “1” represents a printing or existence of a dot in the binary halftone, and “0” represent an empty or omitted dot.)

The problem of representing gray scale images on a binary output device is known as “dithering” or “halftoning.” Halftoning creates the illusion of continuous tone images by judicious arrangement of binary picture elements, simulating the continuous tone image. Dithering relies on the fact that the human visual system integrates information over spatial regions, so that a pattern of light and dark evoke a sensation approximating that of a uniform gray area even when the individual display element can be resolved. In other words, it is the human eye that averages out these dots and creates a grayscale. Effective digital halftoning or dithering can substantially improve the quality of rendering images.

There are many known methods for halftoning, one general class of which is known as error diffusion. Using error diffusion, pixels are scanned or processed serially, (raster order is a commonly used processing order). As the pixels are processed, they are quantized against a threshold parameter and, using a neighborhood operation, the error resulting from the quantization of each pixel, if any, is “pushed forward” such that the error is diffused into nearby pixels that have not yet been processed. In other words, error is spread over neighboring pixels such that localized error in the halftoning process is minimized.

The method or calculus of how the error is distributed determines the resulting patterns. A well known error diffusion method was proposed by Floyd and Steinberg in “An adaptive algorithm for spatial grayscale,” Journal of the Society for Information and Display, vol. 17, no. 2, pp. 75-77, 1976.

However, one shortcoming common to conventional error diffusion techniques, and halftoning methods generally, is that they are designed to operate with respect to whole pixels, and generally do not address or consider that certain output devices have, in varying capacities, the ability to modulate the addition of tone (i.e., printing a dot) at a sub-pixel level. This sub-pixel resolution provides an additional degree of resolution, typically greater in one direction of the pixel grid (most commonly, but not exclusively, the horizontal direction), and moreover provides an opportunity to further spread error associated with the halftoning process in a more continuous and optimal manner in rendering a particular image.

For example, some laser printers may have a horizontal sub-pixel resolution of 2, 3 or more sub-pixels of resolution or addressability for every pixel. Yet, most current error diffusion methods are typically unable to take advantage of the sub-pixel granularity; and as a consequence, such error diffusion methods do not benefit from the higher resolution attendant to sub-pixels and the modulation of tone in less than whole pixel increments.

One advantage of modulating tone (i.e., adding or deleting tone) on a sub-pixel basis is that it allows the addition of tone to be distributed among multiple other pixels or dot clusters, rather than in whole pixels only. And, in the case of error diffusion techniques, being able to apply tone in increments less than whole pixels has the specific advantage of allowing the use of quantization levels, thus preventing the accumulation of error over large errors (relative to the whole pixel case). Since there are more quantization levels there is, accordingly, less quantization noise, which can create smoother and more pleasing halftoning results. An output device without sub-pixel addressability, or more pertinent to the present invention, an output device having sub-pixel capabilities, but unable to utilize or address them in the halftoning process, would be limited to applying additional tone only when the accumulated error, combined with any current pixel input value, had reached an amount sufficient to expose a whole pixel. In such a case, the accumulated error may, then, be applied at a relative pixel distance farther from the original source of the error than desired and in a whole pixel tone element only. This may potentially lead to graininess or other undesirable effects in the ultimate rendering. Conversely, the ability to address sub-pixels and modulate tone on a sub-pixel basis can result in smaller amounts of errors being propagated more immediately adjacent to the origin of error, which can resulting in smoother and more accurate rendering or the original image.

Thus, it would be advantageous to provide a method that enables the generating of halftone images using error diffusion that can take advantage of sub-pixel addressability of certain output devices. Moreover, a particularly desirable solution is one allowing for the use of sub-pixel resolution using known or conventional error diffusion methods, and therefore allowing for the incorporation and consideration sub-pixels when making selections for the location and application of tone when executing such error diffusion methods.

Accordingly, an object of the present invention is a system that can be used to modulate sub-pixels by conventional error diffusion method that otherwise is applicable to whole pixel grids. By conventional error diffusion methods what is meant is any number of error diffusion techniques that affect the propagation of error into neighboring pixels in order to diffuse such error, such that use of the present invention will allow for such method to be used in applications that have sub-pixel tone modulation capabilities.

### SUMMARY OF THE INVENTION

The present invention extends error diffusion (including clustered dot error diffusion methods) to take advantage of sub-pixel modulation for quantization noise reduction for printers with sub-pixel addressability, PWM capability or increased directional addressability.

According to a first aspect of the invention, conventional error diffusion methods are utilized in processing an image to generate a halftone corresponding thereto. In support of the error diffusion process, a look-up table is generated providing a reference of possible, allowable exposure levels and associated alignment justification. These exposure and justification characteristics are correlated or indexed to the current pixel being processed based on the exposure characteristics of neighboring pixels to the current pixel, which neighboring pixels have already been addressed and processed.

Accordingly to a second aspect of the invention, the use of a look-up table seamlessly extends conventional error diffusion methods to sub-pixel error diffusion. By use of a look-up table of possible exposures levels and alignment justifications (collectively referred to as “exposure configurations”), which table's contents are generated given a specific output device's sub-pixel capabilities and other parameters, specific decisions for applying tone resulting from accumulated error can be easily integrated into conventional error diffusion processes.

Moreover, according to another aspect of the invention, one has the capability and control to avoid undesirable/unstable pixel configurations. Where the use of sub-pixels and modulating tone in less than whole pixels is generally desirable, there exist any number of potential exposures that, though justified given the accumulated error, are less than optimal and should be avoided. For example, certain devices having sub-pixel capabilities may be able to ink a single sub-pixel, however such single sub-pixel may be unstable if it is isolated (i.e., not adjacent to a pixel dot of minimum size). Exposure of just such an isolated sub-pixel may be subject to common or expected dropout, such that it should be avoided. The present invention allows for this consideration by configuration of a look-up table having only exposure levels and justification outputs that permit stable or otherwise allowable pixel dot and sub-pixel dot configurations.

According to another aspect of the invention, sub-pixel modulation is directly used to reduce quantization error over the non-sub-pixel modulation case. The generalized objective of minimizing local error inherent in error diffusion methods is enhanced by more refined attenuating of such error by use of higher granularity of quantization levels resulting in lower quantized error and thus lower accumulated error. Subject to unstable exposure and other undesirable configurations, the present invention enables the expression of finer detail and lines through the application of tone at the sub-pixel level, as higher granularity of quantization levels minimizes the accumulation of quantization noise/error over a wider area than is typically possible with whole pixels. Thus, at any given point in the error diffusion processing, the amount of accumulated error pushed forward can be minimized.

These and other advantages of all aspects of the present invention will become apparent to those skilled in the art after having read the following detailed disclosure and illustrated in the following drawings.

### BRIEF DESCRIPTION OF THE DRAWINGS

The present invention is illustrated, by way of example and without limitation, in the figures of the accompanying drawings in which:

FIG. 1 shows a pixel view diagram of a sample scan progression using an error diffusion method, and a generalized logic diagram applicable to error diffusion methods;

FIG. 2 shows a schematic of a representative pixel grid and the relation of sub-pixel resolution thereto;

FIG. 3 illustrates examples of potentially undesirable and sub-optimal sub-pixel exposures capable of being avoided using the present invention;

FIG. 4A is a graphical representation of one element of a look-up table generated according to the present invention;

FIG. 4B shows representative exposures of the sample look-up table entry of FIG. 4A;

FIG. 5 is a flow diagram depicting steps of generating a halftone image using an error diffusion method according to the present invention;

FIG. 6A shows a 25% halftone image generated using error diffusion, without benefit of the present invention; and

FIG. 6B shows a 25% halftone image using sub-pixel modulation, generated according to the present invention.

### DETAILED DESCRIPTION

A method of extending conventional error diffusion halftoning to take advantage of higher addressability (i.e., at a sub-pixel level of resolution) or pulse width modulation (PWM) capability of an output device, such as a printer, is disclosed. In such cases, the output device typically has a greater resolution in the horizontal direction than in the vertical direction. In laser printers, for example, the increased addressability is obtained by laser pulse width modulation (PWM). This can be more generally referred to as sub-pixel modulation, when a uniform resolution (i.e., whole pixels) exists in both directions, and “S” sub-pixels counted in one direction (e.g., the horizontal direction) make up one printer pixel. Accordingly, the present invention involves the use of error diffusion techniques to utilize the sub-pixel modulation capabilities of certain output devices.

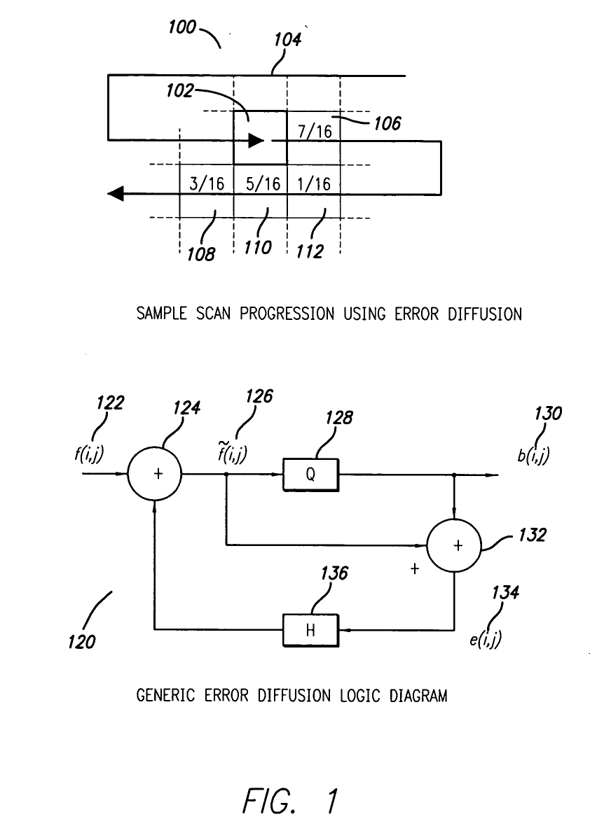

In FIG. 1 a pixel view 100 of an error diffusion processing is shown on a representative portion of a pixel grid. Current pixel 102 is shown in the sequence of the scan or processing order indicated by line 104. Processing order 104 is depicted as a serpentine scanning order, which is by of example only, and not by way of limitation. Other forms or orders for processing pixels using error diffusion are known and commonly implemented, one alternative being, for example, raster order.

As the grid is processed along scanning order 104, it is notable that adjacent to current pixel 102 are some pixels that have already been scanned or processed, as well as other pixels remaining to be processed. Immediately adjacent to current pixel 102 are pixels 106, 108, 110 and 112, all of which are later in the scanning order and have yet to be processed. These pixels may be, depending on the specific error diffusion method employed, immediately affected by error “pushed forward” during the error diffusion processing. By way of example, using a known point spread function of the error diffusion filter proposed by Floyd and Steinberg, each of the pixels 106, 108, 110 and 112 are to receive a fractional portion of the error of current pixel 102, if any, in the proportions of 7/16, 3/16, 5/16 and 1/16, respectively. And, as each pixel is later processed, it propagates any residual error in similar fashion. While this is a specific example of an error diffusion scheme, the current invention is not limited to use with such example or type of error diffusion, and the exemplary choice made is for illustrative purposes only. Any number of alternative error diffusion methods may be employed distributing error to adjacent un-processed pixels, or to a possibly broader range of neighboring pixels that are in close proximity, though not necessarily adjacent, to the currently processed pixel.

Also shown in FIG. 1 is a block diagram 120 illustrating the generic logic of error diffusion methods. The current pixel 102 provides an input f(i,j) 122 which is modified at 124 by a calculus of past quantization errors to create a modified input \tilde{f}(i,j) at 126. This modified value is then compared to a threshold value that quantizes the modified input \tilde{f}(i,j) to a binary output value b(i,j) at 130. This quantized output b(i,j) is the binary halftone image, representing whether a dot is printed at the current pixel or not.

The resulting error 134 is calculated as the difference between the binary output value at 130 and the modified input value 126, i.e., e(i,j)=\tilde{f}(i,j)−b(i,j). The resulting error e(i,j) 132 is then fed through a weighting filter/error diffusion calculus 136, commonly referred to as a diffusion filter. Diffusion filter 136, according to its diffusion scheme, allocates the input error e(i,j) of 134 among other neighboring pixels that have not yet been process. The example of one such diffusion scheme and the distribution of error is shown in the pixel view 100 described in the immediately preceding paragraphs. Thus, it is the then-current error, e(i,j), which may be an accumulation of error of one or more prior pixels, that is used at 124 to modify a specific pixel's original input value f(i,j) at 122 to generate the modified input value \tilde{f}(i,j) at 126.

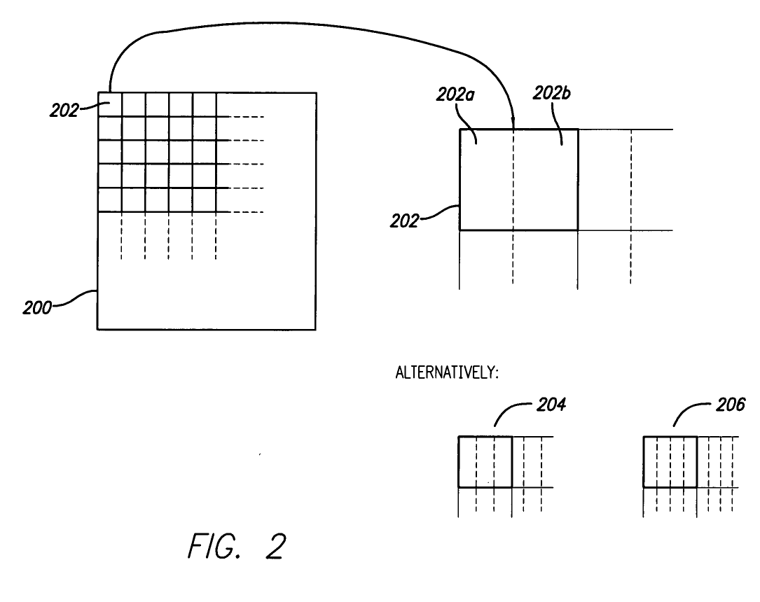

Referring now to FIG. 2, a schematic of a representative pixel grid 200 is shown. Pixel grid 200 is comprised of a plurality of addressable pixels, such as pixel 202. It is this generic form of pixel grid upon which error diffusion methods are applied, as described just previously. However, many output devices today have a higher level of resolution in one direction. For example certain printers have pulse width modulation (PWM) capability that extends resolution typically in the horizontal direction. Pulse width modulation, though a specific example, belongs to a generalized situation characterized by an output device having some amount of sub-pixel addressability that allows for modulation of tone at the sub-pixel level. In such cases, each pixel, e.g., pixel 202, has a corresponding set or distribution of sub-pixels, such as sub-pixels 202a and 202b, based on degree of sub-pixel resolution attendant to the application. In the example of sample pixel 202, the degree of resolution is two sub-pixels per pixel, which resolution extends horizontally. However, the sub-pixel resolution (also referred to herein as sub-pixel factor S) of 2 is only by way of example and without limitation. Alternative sub-pixel resolutions of S=3 and S=4 are also shown in FIG. 2, and the actual sub-pixel resolution depends on the specific output device for which the halftone image is being processed. Additionally, it is not a requirement or limitation of the present invention that sub-pixel resolution be constrained to the horizontal direction.

The benefit of sub-pixel resolution in modulating the addition (deletion) of tone in application of error diffusion methods includes the ability to apply partial tone which makes for better transitions. Generally speaking, more quantization error is grainier in comparison to less quantization error and, with the benefit of the present invention, lower or smaller quantization steps are available (based on the degree of sub-pixel addressability) which generally results in less quantization noise/error.

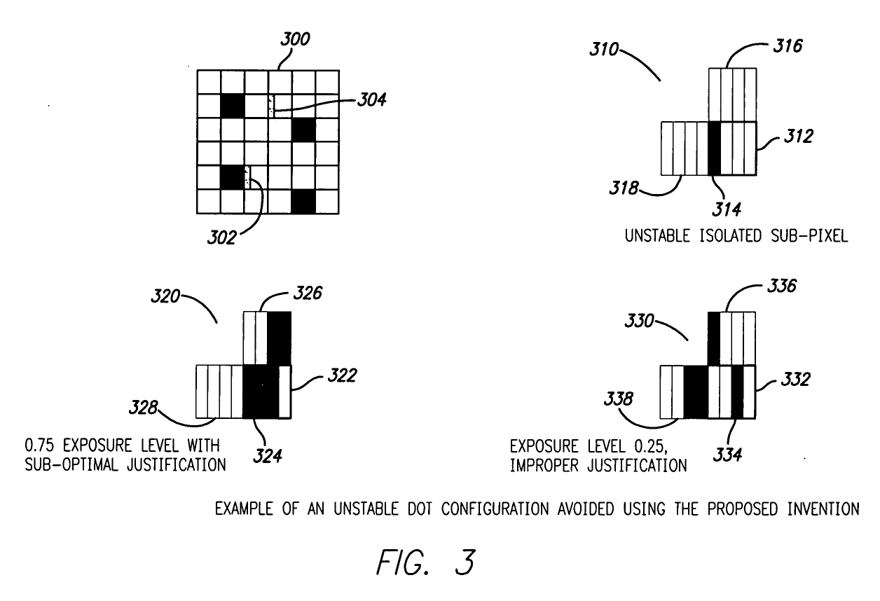

However, turning now to FIG. 3, although being able to apply diffused error on a sub-pixel basis has clear advantages, there are circumstances that may limit sub-pixel tone modulation which need to be considered. It is not uncommon for any given output device that there exist only certain sub-pixel configurations that reliably reproduce. Sub-pixel dot 302 of FIG. 3 may reliably reproduce because it is adjacent to a whole pixel dot, whereas the same tone amount of the single sub-pixel dot 304 may fail to transfer or reproduce reliably because it is isolated and not next to a full or larger pixel dot. Any number of practical rendering or reproducing issues are possible when considering the application of tone using sub-pixels. By way of illustration and without limitation, FIG. 3 depicts a non-exclusive sampling of conceivable sub-pixel exposure configurations that it might be desirable to avoid due to practical limitations or considerations. In each example the error diffusion process is scanning left to right, so the previously scanned pixels immediately above and to the left of the current pixel provide context in predicting the reliability or desirability of the particular sub-pixel exposure configuration. In each example the current pixel is identified with a highlighted border. Each example is based on a sub-pixel resolution factor of S=4.

Example 310 is analogous to the previous grid 300 having an isolated sub-pixel 304. For current pixel 312, the above pixel 316 and left pixel 318 are both blank (i.e., “0”). Accordingly, the single, left-justified sub-pixel 314 may be an unstable exposure configuration. The single sub-pixel may be subject to dropout or otherwise unreliable to reproduce because it is not contiguous with sufficient additional pixel or sub-pixel dots. In this case, the option is not to apply any tone to pixel 312 and let the error continue to be pushed forward until a more reliably reproducible exposure configuration arises.

Example 320 is an example of what may be a reliably reproducible exposure configuration, however it is less than optimal. The subject current pixel 322 is comprised of a three-quarter exposure that is left-justified 324. Since above pixel 326 is half exposed, right-justified and left pixel 328 is blank, a more reliable cluster dot formation for the exposure of pixel 322 may be to right-justify such that the whole dot (the contiguous inked portion of 322 and 326) are more centrally clustered.

Finally, in example 330, subject current pixel 332 is comprised of a single sub-pixel exposure 334 which is right-center justified. Thus, this configuration is similar to example 330, showing a single isolated sub-pixel. However, in this example, it may be possible to apply tone based on the exposure configurations of above pixel 336 and left pixel 338 if a different justification is used. Though not reliably reproducible in its current justification, sub-pixel 334 may be applied if a left justification is used.

The foregoing cases are a few examples that, depending on the output device, are used in a particular application in determining allowable exposure configurations (exposure and justification) from the list of possible or conceivable exposure configurations. These allowable configurations are then used to create or generate a referencable table or database that is indexed based on the exposure configuration(s) of certain neighboring pixels that have already been processed in relation to the current pixel. It should be noted for clarity that sub-pixel dots 302 and 304 are shown in a lighter shade for highlighting their locations to the reader, and it should be appreciated that in the present description the pixels and sub-pixels referred to are binary outputs (either a dot or no dot), and the use of shaded elements is for illustrative purposes only.

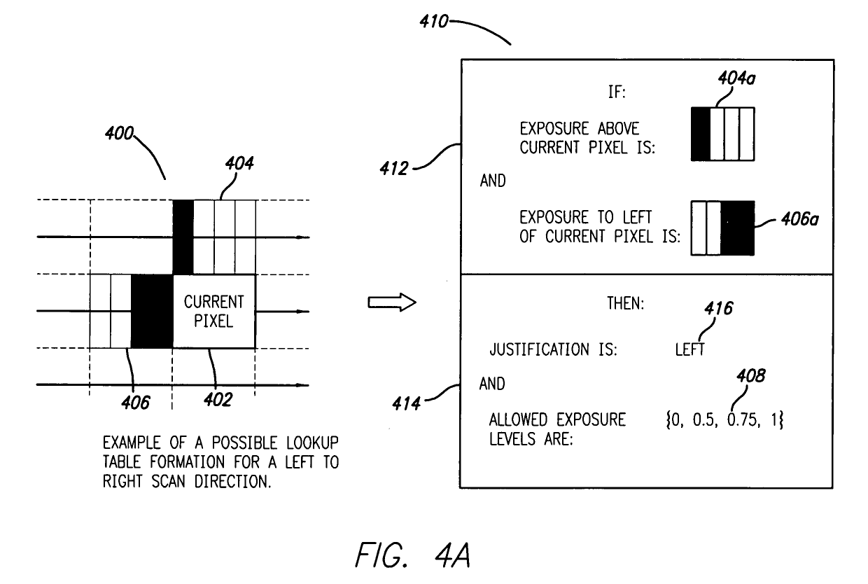

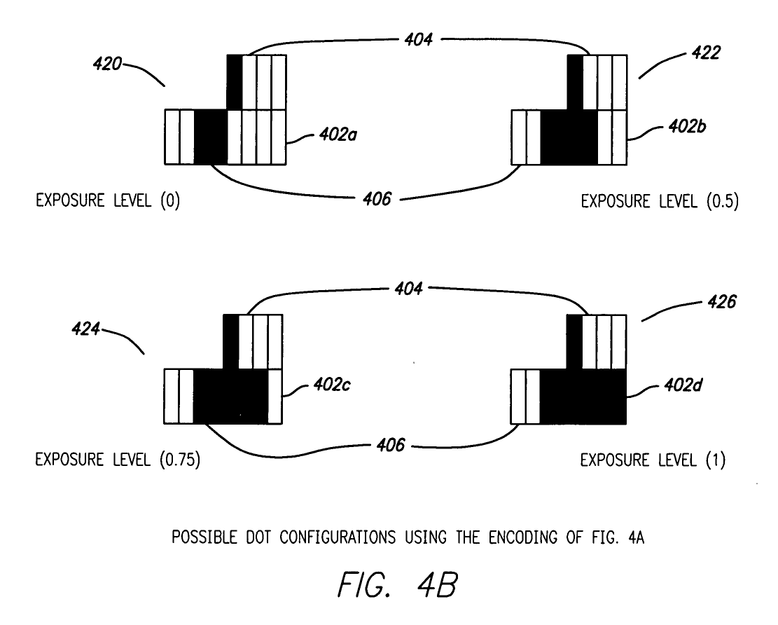

Directing the reader's attention to FIG. 4, according to the present invention, a lookup table or similar referencable database is employed to determine the application of tone at the sub-pixel level. The lookup table entries use as inputs the exposure configuration of one or more pixels neighboring or directly adjacent to the currently processed pixel, which neighboring pixels have already been addressed in the scanning process and for which an exposure level has already been determined. For example, when pixels are being processed in raster order (left to right, top to bottom) each pixel addressed has, as the then-current pixel, adjacent cells above and to the left which have already been processed. For each such current pixel, the exposure configurations of these adjacent pixels are available (having been previously and decided on) as inputs to a lookup table. And in the case of any particular application of the present invention, an array or set exists for all the possible exposure permutations of these adjacent processed pixels, wherein the specific application takes into consideration the sub-pixel resolution of the output device used and which of the various neighboring processed pixels are to be used as relevant inputs to the lookup table. In the present description a sub-pixel resolution of 4 is use, by way of example, and the relevant input pixels are pixels immediately above and to the left of the current pixel, based on a raster order scanning process. Use of other sub-pixel resolutions, and alternate or additional input pixels and scanning orders will be evident to one skilled in the art in light of the present description. A broader range of pixels, such as diagonal upper-left or upper-right for example, might be employed, however the preferred embodiment uses the above and left pixels only.

Referring now to FIG. 4A, an entry or data set of a sample lookup table is shown in graphical form based on a left to right scan and indexed based on the pixels immediately above and to the left of the current pixel. As the pixels are processed, each pixel is addressed and is at that time the current pixel 402. Subject to certain boundary limitations at the edges of the image, each current pixel 402 has immediately above and to the left of it neighboring pixels 404 and 406, respectively, which have previously been processed. Pixels 404 and 406 have the exposure configurations shown (i.e., one quarter exposure with left justification, and half exposure with right justification, respectively). Many alternative combinations of exposure configurations exist for the two adjacent pixels above and to the left of current pixel, and it is this set of possible combinations that form the basis of the entries of the lookup table. And, during scanning of pixel during the error diffusion processing, the lookup table is systematically accessed based on the combination of neighboring input pixels (e.g., pixels 404 and 406) to retrieve allowable exposure configurations applicable to the current pixel based on these neighboring input pixels.

Continuing with the example of FIG. 4A, the specific exposure combination rendered by neighboring pixels 404 and 406 have a corresponding entry 410 in the lookup table. Input or index element 412 of the lookup table represented by pixels 404 and 406 is essentially the predicate in an a conditional logic statement: IF the current pixel has as its neighboring pixels exposure configurations X and Y (pixels 404a and 406a in this example); THEN there is a set of allowable exposure configurations 414 which may be applied to the current pixel (provided the modified input value \tilde{f}(i,j) for the current pixel is sufficient). Thus entry 410 has allowable exposure configurations 414 indicated as a left justification (416) and four possible exposure levels {0, 0.5, 0.75, 1} at 408.

Each of the allowable exposure configurations 414 indicated in relation to the specific neighboring input pixels 412 are represented graphically in FIG. 4B at 420, 422, 424 and 426. As indicated at 416, the justification setting is LEFT. Note there is not an allowable exposure configuration for one quarter exposure (0.25). This is an instance in which a particular sub-pixel exposure configuration is avoided using the present invention because, in the present example, an isolated single sub-pixel does not reliably reproduce. Though a conceivable or possible configuration, if the modified input of the current pixel does not threshold to at least a half exposure (0.5), then the current pixel will remain untoned and the accumulated error will continue be pushed forward in the processing order.

The difference between possible exposure levels and allowable exposure levels is based on which, if any, of the possible exposure levels are stable and can be reliably reproduced in a given setting or system, or other considerations that make such an exposure configuration undesirable. FIG. 3 and the related description thereto illustrates some examples of this. Accordingly, each lookup table entry is preferably generated to eliminate from consideration the application of tone to the current pixel in configurations that are undesirable. Generally, there are S+1 possible exposure levels for any particular application (where S is the number of sub-pixel per pixel), since exposure for a particular pixel can be incremented by the number of sub-pixels (S) plus the potential of no exposure. In the current case represented in FIG. 4A there are five possible exposure levels corresponding to incrementally applying tone to one, two, three or four sub-pixels, plus the option of applying no tone in the current pixel; however only four are allowable.

For clarity, it is feasible to have more than S+1 exposures levels, if one considers the possibility of bifurcating an exposure setting within a pixel. In other words, one could expose two sub-pixels in a split format in the same pixel, whereby one sub-pixel is justified left and one sub-pixel justified right. Yet, whether such a configuration would be stable, reproducible, etc. would need to be evaluated. Thus any number of combinations and justification regimens can be employed, though the complexity of any such approach must be considered by balancing the computing costs and ultimate halftoning improvement and other benefits.

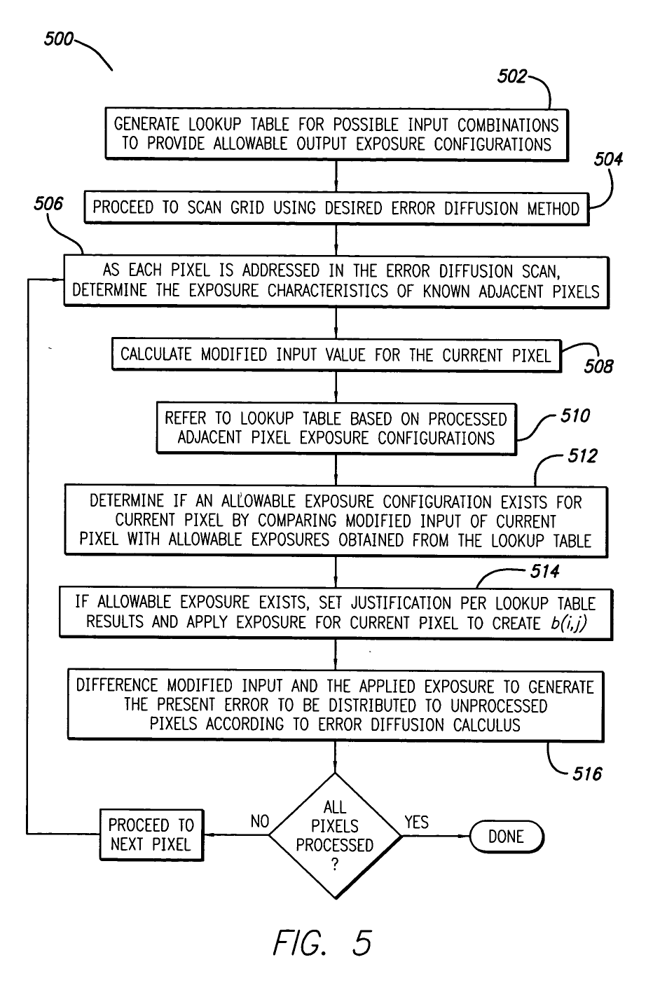

Referring now to FIG. 5, reference is made to flow diagram 500 illustrating steps comprising an embodiment of the present invention. For any particular application, various parameters are considered in applying the presently described method, including, without limitation, the sub-pixel limitation of the particular output device, the nature and limitation of any exposure configurations that may be undesirable (e.g., unstable, unreliable, etc.), the scan direction of the error diffusion method employed, and which of past processed neighboring pixels are to be considered as indices to the lookup table.

Given such parameters, a lookup table is generated at 502 which will provide a determination source in deciding the specific application of tone with respect to specific pixels as they are processed beginning at step 504. The lookup tables are preferrably different for different scan directions and for light (<0.5) and dark tones (>0.5).

At 506, as each pixel is scanned in order according to the error diffusion method chosen, the characteristics of certain previously processed pixels adjacent to the current pixel are identified. In an application, such as the one previously described in reference to FIG. 4, as each pixel is processed the pixels immediately above and to the left of the current pixel are identified and their exposure configurations determined. With the adjacent input pixel configurations known, the current modified input value \tilde{f}(i,j) is also determined for the current pixel at 508. As would be evident to one skilled in the art, it is not essential that the adjacent pixel exposure configurations be determined (step 506) prior to determination of modified input for the current pixel (step 508); rather it is only essential to the present invention that the two steps be completed prior to accessing the lookup table at the next step 510.

At step 510, in the cycle of processing each pixel, the lookup table is accessed based on the exposure configurations of the relevant adjacent pixels determined at step 506. Then, the modified value for the current pixel is used to select to select one of the allowable exposure levels at 512. In other words, the modified input value for the current cell is used at 512 to determine from the accessed lookup table entry which of the allowable exposure levels will be applied. This selection process may be by rounding to the nearest allowable exposure value, given the modified input \tilde{f}(i,j) for the current pixel. Alternatively, the selection step may be comprised of a truncation method whereby the exposure chosen is that which is the greatest allowable exposure (from those available given the neighboring cell configurations) and which does not exceed the modified input. Though the preferred embodiment contemplated herein using a rounding approach in selecting from allowable exposure configurations, there are, as will be evident to one skilled in the art, other selection modes (e.g., biasing or weighting to a certain value in certain circumstances) for conjugating from the modified input for the current pixel to determine (from the available exposure configurations) which exposure will be selected and applied. Thus, in any event, a comparison is made of the modified input value \tilde{f}(i,j) to the allowable exposure levels (e.g., 408 of FIG. 4B), given the corresponding quantization values associated with the current pixel (e.g., one quarter exposure for a four sub-pixel system is achieved when modified input \tilde{f}(i,j) is rounds closest to 0.25 of the applicable threshold).

Thus, the comparison at step 512 checks the modified input value \tilde{f}(i,j) as a fractional portion of the threshold value for the instant current pixel and determines/confirms if at least one allowable exposure exists in the table entry (other than the always available “no exposure” result). If one or more allowable exposures are found to exist at step 512, as determined from the lookup table entry, then the exposure level that is closest to the value for the current pixel is selected at 514 (unless some other selection method is used, as suggested above). For instance, if a particular table entry has possible exposures {0, 0.5, 0.75, 1.0} and the current pixel value is 0.61, (\tilde{f}(i,j)/Q(i,j)), then exposure level 0.5 is selected for the current pixel, as 0.5 closest allowable exposure value, thereby resulting in the smallest possible rounding error from the current pixel. Accordingly, at step 514, if an allowable exposure was found to exist, then a corresponding sub-pixel pattern (or PWM code) is formed using exposure level and the justification selected. The justification indicated in the accessed lookup table entry is set and the appropriate exposure level just previously determined is applied to the current pixel. The justification and applied exposure level (i.e., the exposure configuration) of the current pixel is output as the binary image output b(i,j) for the current pixel.

Finally, at step 516, the new current error e(i,j) is determined and diffused or “pushed forward” in the error diffusion process to future unprocessed pixels using the error diffusion scheme. The new current error e(i,j) is the difference between the modified input of the current pixel \tilde{f}(i,j) and the exposure level just applied. Thus, using the example of the immediately preceding paragraph, the modified input and applied exposure were 0.61 and 0.50, respectively, so the new current error would be 0.11. And, using the error diffusion calculus specifically employed in the application, this remaining error is distributed to future addressed pixels; and the cycle moves sequentially to the next pixel to continue the error diffusion process at 506.

These and other modifications and variations may be employed without departing from the inventive elements herein described, as one skilled in the art will appreciate in practicing the disclosed invention. Thus, the foregoing detailed description of the present invention is provided for the purpose of illustration and is not intended to be exhaustive or to limit the invention to the precise embodiments disclosed. Accordingly, the scope of the present invention is defined by the appended claims.

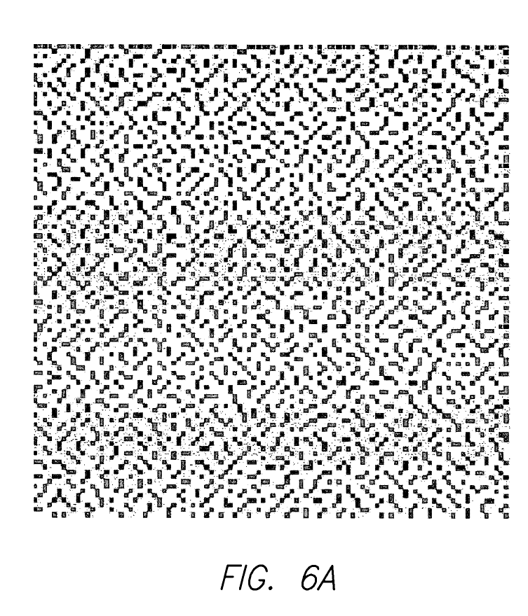

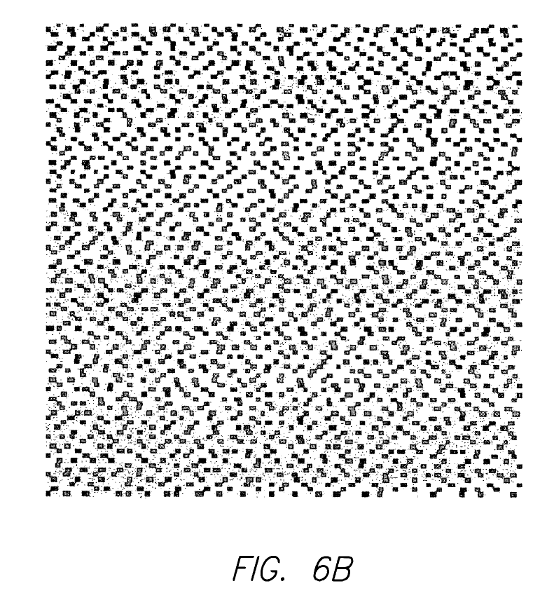

FIG. 6A illustrates a 25% gray level halftone image processed using error diffusion without benefit of the present invention and use of sub-pixel modulation, which results in a lot of isolated pixels that can lead to unstable configurations. This is in contrast to FIG. 6B which is the same 25% halftone image processed using sub-pixel modulation in accordance with the present invention.

1. A method of generating a halftone image comprised of a plurality of pixels, each pixel further comprised of two or more sub-pixels, the method comprising:
a. Generating a lookup table providing allowable sub-pixel exposure configurations;
b. Processing the pixels in a sequential order using an error diffusion technique; and
c. Selecting from the lookup table an allowable sub-pixel exposure configuration for each pixel as it is processed.

2. The method of claim 1 whereby the lookup table providing allowable exposure configurations is indexed based on at least one exposure characteristic of one or more pixels neighboring the pixel currently being processed.

3. The method of claim 2 wherein the neighboring pixels, used in selecting from the lookup table, have already been processed.

4. The method of claim 3 wherein the neighboring pixels are adjacent to the pixel currently being processed.

5. The method of claim 1 whereby the allowable exposure configurations provided by the lookup table each comprises a justification value and an exposure level.

6. The method of claim 5 wherein the justification values and exposure levels provided by the lookup table are consequent to sub-pixel capabilities of an output device for which the halftone image is generated.

7. The method of claim 5 whereby the justification value of an allowable exposure configuration is either left or right.

8. The method of claim 5 wherein the step of selecting further comprises setting the justification and applying a tone associated with the exposure level of the selected allowable exposure configuration.

9. The method of claim 8 whereby the exposure level setting for at least one of the allowable exposure configurations corresponds to no tone being applied.

10. The method of claim 1 wherein, for the pixel currently being processed, the step of selecting from the lookup table is based on (i) an exposure characteristic of one or more neighboring pixels and (ii) a modified input value for the pixel currently being processed.

11. The method of claim 10 wherein the step of selecting an allowable exposure configuration further comprises comparing the modified input value for the current pixel with allowable exposure configurations provided by the lookup table.

12. A method of generating a halftone image for an output device using error diffusion to process a plurality of pixels in a sequential order, said output device having sub-pixel addressability, the method comprising:
a. Creating a lookup table indicating one or more allowable exposure configurations for a currently processed pixel based on exposure characteristics of one or more pixels neighboring said current pixel;
b. Accessing the lookup table for the current pixel;
c. Identifying the allowable exposure configurations for the current pixel;
d. Selecting an allowable exposure configurations for the current pixel; and
e. Applying the selected allowable exposure to the current pixel.

13. The method of claim 12 whereby said one or more neighboring pixels are comprised of pixels adjacent to the current pixel.

14. The method of claim 12 wherein the step of selecting one or such allowable exposure configurations further comprises comparing a modified input value for the current pixel with allowable exposure configurations provided by the lookup table.

15. The method of claim 14 wherein the step of comparing a modified input value to select an allowable exposure configuration comprises identifying an exposure configuration having an exposure level closest to said modified input value.

16. The method of claim 14 further comprising the step of differencing the modified input value of the current pixel and applied exposure to generate a present error value to be propagated forward in the error diffusion processing.

17. The method of claim 12 wherein each allowable exposure configuration is comprised of a justification and an exposure level setting, said justification and exposure settings being consequent to capabilities of the output device and the sub-pixel addressability.

18. The method of claim 17 wherein the step of applying further comprises the steps of setting the justification and applying the exposure level.

19. The method of claim 17 whereby the justification setting of an allowable exposure configuration is either left or right.

20. The method of claim 17 whereby the exposure level setting for at least one of the allowable exposure configurations corresponds to the application of no tone.

21. A method of processing an image using error diffusion to generate a halftone image for an output device having sub-pixel resolution, the method comprising:
a. Generating a lookup table
i. indexed by possible exposure characteristics of one or more neighboring pixel to a current pixel, and
ii. indicating allowable exposure configurations for the current pixel, each allowable exposure configuration comprised of a justification value and an exposure value;
b. As each pixel is processed as the current pixel using the error diffusion technique
i. Determining the exposure characteristics of one or more neighboring pixels which have been processed previous to the current pixel;
ii. Calculating a modified input value for the current pixel;
iii. Referring to the lookup table based on the exposure characteristics of at least one pixel neighboring the current pixel to identify allowable exposure configurations for the current pixel;
iv. Selecting from the allowable exposure configurations by comparing the modified input value for the current pixel with an exposure level associated with each allowable exposure configuration; and
v. Applying the selected allowable exposure by setting the justification for the current pixel and applying the tone associated with the exposure level.

22. The method of claim 21 wherein said neighboring pixels are adjacent to the current pixel.

23. The method of claim 21 wherein the step of comparing the modified input value comprises identifying exposure level of the allowable exposure configurations closest to the modified input value of the current pixel.
